(19) United States
(12) Patent Application Publication
(10) Pub. No.: US 2017/0103147 A1
(43) Pub. Date: Apr. 13, 2017

(54) VEHICLE CONFIGURATION USING SIMULATION PLATFORM

(71) Applicant: Honda Motor Co., Ltd., Tokyo (JP)

(72) Inventors: Rahul Khanna, Plantation, FL (US); Robert Wesley Murrish, Santa Clara, CA (US)

(21) Appl. No.: 14/881,730

(22) Filed: Oct. 13, 2015

(51) Int. Cl. G06F 17/50; G06N 7/00; G06N 99/00

(52) U.S. Cl. CPC G06F 17/5009; G06N 99/005; G06N 7/005

(57) ABSTRACT

One or more aspects for managing a vehicle configuration or implementing a vehicle configuration within a vehicle are disclosed herein. A vehicle configuration profile may be built by receiving simulation inputs associated with an entity, executing and rendering a simulation for a vehicle type within a simulation environment, providing simulation stimuli within the simulation environment, monitoring driving parameters provided in response to the simulation stimuli and building the vehicle configuration profile based on the driving parameters. A vehicle configuration may be implemented within a vehicle by receiving a vehicle configuration profile, sensing actual conditions, and operating the vehicle based on the vehicle configuration profile and actual conditions. The vehicle configuration profile may be indicative of a preferred driving style associated with the entity during transport across a plurality of simulated conditions.

### BACKGROUND

Autonomous vehicles generally perform autonomous driving and may include technology to avoid obstacles or objects along a route. Ideally, an autonomous vehicle may be capable of providing transportation in the same or a similar fashion as a vehicle, but in a self-driving fashion. Autonomous vehicles may sense surrounding objects or obstacles using radar, lidar, or computer vision. However, these vehicles may require extremely detailed or specialized maps to operate as desired. Further, reliability and accuracy of autonomous vehicle operation is not yet perfected in that humans may often make better decisions than computer piloted autonomous vehicles.

### BRIEF DESCRIPTION

According to one aspect, a system for managing a vehicle configuration includes an interface component, a simulation component, a capture component, and a configuration component. The interface component may receive one or more simulation inputs associated with an entity. One or more of the simulation inputs may be a vehicle type or an input driving style. The simulation component may execute and render a simulation for the corresponding vehicle type within a simulation environment. The simulation component may provide one or more simulation stimuli within the simulation environment. The configuration component may build a vehicle configuration profile based on one or more of the driving parameters. The vehicle configuration profile may be associated with the entity.

The interface component may receive identification data associated with the entity. The simulation component may render 3D images of the simulation environment or one or more of the simulation stimuli. One or more of the simulation stimuli may include a pedestrian, one or more different weather conditions, one or more different temperature conditions, traffic conditions, or a turning maneuver. One or more of the driving parameters may include a steering angle, a braking force, vehicle velocity during a turning maneuver, following distance, or a change in steering angle over time during a driving maneuver. The system for managing a vehicle configuration may include a learning component inferring one or more driving parameters based on one or more of the monitored driving parameters. The vehicle configuration profile may be indicative of a preferred driving style associated with the entity during transport. The configuration component may transmit the vehicle configuration profile.

According to one aspect, a system for implementing a vehicle configuration within a vehicle may include a communication component, a sensor component, and an application program interface (API) component. The communication component may receive a vehicle configuration profile associated with an entity. The vehicle configuration profile may be indicative of a preferred driving style associated with the entity during transport across a plurality of simulated conditions. The sensor component may sense one or more actual conditions. The application program interface (API) component may operate the vehicle based on the vehicle configuration profile and one or more of the actual conditions.

The system for implementing a vehicle configuration may include a storage component storing the vehicle configuration profile. The system for implementing a vehicle configuration may include a navigation component receiving one or more navigation maneuvers. The API component may operate the vehicle based on one or more of the navigation maneuvers and the vehicle configuration profile. The API component may operate the vehicle in an autonomous fashion. The sensor component may be configured to detect objects or pedestrians, provide a video feed, utilize radar or lidar, receive one or more different weather conditions or one or more different temperature conditions, or provide a compass heading.

The system for implementing a vehicle configuration may include a display component rendering the video feed or one or more notifications associated with one or more of the actual conditions detected by the sensor component. One or more of the actual conditions may include a pedestrian, one or more different weather conditions, one or more different temperature conditions, traffic conditions, or a turning maneuver. The system for implementing a vehicle configuration may include a style component adjusting the vehicle configuration profile based on feedback from the entity or an associated user.

According to one aspect, a method for implementing a vehicle configuration within a vehicle may include receiving a vehicle configuration profile associated with an entity, the vehicle configuration profile indicative of a preferred driving style associated with the entity during transport across a plurality of simulated conditions, sensing one or more actual conditions, and operating the vehicle based on the vehicle configuration profile and one or more of the actual conditions.

The method may include receiving one or more navigation maneuvers and operating the vehicle based on one or more of the navigation maneuvers and the vehicle configuration profile. The method may include operating the vehicle in an autonomous fashion or adjusting the vehicle configuration profile based on feedback from the entity or an associated user.

### BRIEF DESCRIPTION OF THE DRAWINGS

FIG. 1 is an illustration of an example component diagram of a system for managing a vehicle configuration and a system for implementing a vehicle configuration within a vehicle, according to one or more embodiments.

FIG. 2 is an illustration of an example flow diagram of a method for managing a vehicle configuration, according to one or more embodiments.

FIG. 3 is an illustration of an example flow diagram of a method for implementing a vehicle configuration, according to one or more embodiments.

FIG. 4 is an illustration of an example computer-readable medium or computer-readable device including processor-executable instructions configured to embody one or more of the provisions set forth herein, according to one or more embodiments.

FIG. 5 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

The following terms are used throughout the disclosure, the definitions of which are provided herein to assist in understanding one or more aspects of the disclosure.

As used herein, the term “infer” or “inference” generally refer to the process of reasoning about or inferring states of a system, a component, an environment, a user from one or more observations captured via events or data, etc. Inference may be employed to identify a context or an action or may be employed to generate a probability distribution over states, for example. An inference may be probabilistic. For example, computation of a probability distribution over states of interest based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several event and data sources.

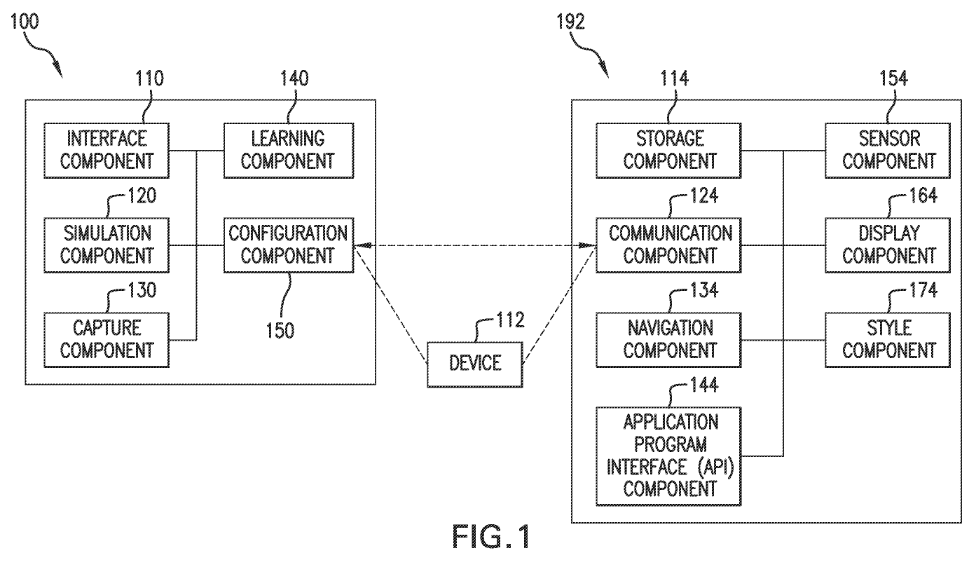

FIG. 1 is an illustration of an example component diagram of a system 100 for managing a vehicle configuration and a system 192 for implementing a vehicle configuration within a vehicle, according to one or more embodiments.

The system 100 for managing a vehicle configuration may include an interface component 110, a simulation component 120, a capture component 130, a learning component 140, and a configuration component 150.

In one or more embodiments, the system 100 for managing a vehicle configuration may be a simulation platform. An interface component 110 may receive one or more simulation inputs associated with one or more entities. Simulations inputs may include a vehicle selection of a vehicle make, a vehicle model, a vehicle type (e.g., semi-truck, sedan, compact car, etc.), one or more vehicle options, a transmission type, drive type (e.g., all-wheel drive, front-wheel drive, rear-wheel drive), etc. In other words, the vehicle selection generally relates to aspects of a vehicle, similarly to aspects which would be chosen while purchasing a vehicle, for example. In this way, the simulation component 120 may provide these simulation inputs to the simulation component 120 for appropriate or corresponding simulations for the selected type of vehicle or vehicle selection.

Another example of a simulation input may include a driving style. For example, a driver or use may indicate to the interface component 110 that he or she is generally an aggressive driver, a passive driver, etc. Similarly, this information may be provided by the interface component 110 to the simulation component 120 to provide a more accurate simulation experience to a user building a vehicle configuration profile. Thus, the interface component 110 may receive one or more simulation inputs associated an entity, wherein one or more of the simulation inputs is a vehicle type or an input driving style.

Further, the interface component 110 may determine an entity associated with one or more of the simulation inputs. For example, the interface component 110 may query a user to determine who or what the simulation (to be generated by the simulation component 120) pertains to in general. In other words, the interface component 110 may determine an entity for which a vehicle configuration profile is to be generated. As an example, a user could be a driver of a vehicle, who will be provided with a simulation experience via the simulation component 120. From here, the capture component 130 may monitor one or more responses that driver has to different stimuli, and the configuration component 150 may generate a vehicle configuration profile for that driver. This vehicle configuration profile may be indicative of the driver's driving style or how the driver prefers his or her ride to maneuver.

In any event, the interface component 110 may gather, receive, confirm, or collect identification data indicative of an associated entity (e.g., driver, cargo, etc.). In one or more embodiments, an entity may include different individuals, such as users, operators, drivers, passengers, or occupants of a vehicle. In other embodiments, entities may include different types of cargo, or goods. Stated another way, because entities may include goods or cargo, simulation inputs may be associated with the same instead of people or individuals. For example, fragile goods or cargo may be transported more carefully or according to different transport protocol, which may be modeled by the system 100 for managing a vehicle configuration as a vehicle configuration profile.

The simulation component 120 may run, provide, or execute a simulation associated with a vehicle corresponding to the vehicle selection or driving style. In other words, using the inputs provided by the interface component 110, the simulation component 120 may run a simulation which appears as a vehicle selected by the user according to the simulation inputs provided. For example, if a user selects a Honda Civic as his or her vehicle using the interface component 110, the simulation component 120 may simulate a Civic driving through a simulation environment or a virtual reality environment.

The simulation component 120 may provide one or more 3D images or one or more 2D images of the virtual reality environment or simulation environment, thereby ‘simulating’ operation of a corresponding vehicle within the simulation environment. Further, the simulation component 120 may provide or render images of one or more simulation stimuli within the simulation environment. In other words, the simulation component 120 may render objects, obstacles, or conditions which may cause drivers to ‘react’.

Examples of simulation stimuli may include a pedestrian, another vehicle, one or more different weather conditions, such as rain, sunshine, snow, etc., one or more different temperature conditions, different traffic conditions, different terrain, navigation maneuvers along one or more road segments, etc. In this way, the simulation component 120 may cause a user or ‘driver’ in a simulation environment to operate a simulation vehicle or simulated vehicle in a plurality of simulated conditions. Further, the simulation component 120 may provide artificial or simulated pedestrian detection, a camera or video feed of an exterior of the simulated vehicle, a current speed or velocity, a compass heading, radar or lidar alerts regarding objects or obstacles, sensor alerts pertaining to rain, temperature, or weather conditions, sensor alerts pertaining to simulated vehicle components, etc., collision or accident alerts or notifications, etc. In any event, these simulation stimuli may facilitate determination of a user or driver's driving style.

The capture component 130 may monitor one or more driving parameters provided in response to one or more of the simulation stimuli. For example, the capture component 130 may monitor how a driver of a simulated vehicle responds to snow on the roadway and note associated driving parameters which change with respect to that type of weather condition (e.g., as opposed to a ‘control’ simulation experience when the driver is provided with as little simulation stimuli as possible). Here, the capture component 130 may note or record that the driver operates the simulated vehicle at about ten percent slower of a speed or velocity when precipitation, such as snow or rain, is present.

According to other aspects, the capture component 130 may monitor one or more driving parameters attributed to the entity associated with a vehicle configuration profile or the entity associated with the simulation inputs. In other words, the capture component 130 may observe that fragile cargo is associated with turns which are taken no greater than five miles per hours, for example. In yet another aspect, the capture component 130 may monitor driver parameters for the same user across different simulated vehicles or vehicle types and note the driving style or driving parameters based on vehicle capabilities. For example, a user may operate a sports car more aggressively than when the user is operating a minivan with kids in the backseat. In this way, the capture component 130 may determine one or more driving parameters in response to different simulation stimuli, entities, vehicle capabilities, etc.

Examples of driving parameters which may be monitored by the capture component 130 may include a steering angle, a braking force, vehicle velocity during a turning maneuver, following distance, or a change in steering angle over time during a driving maneuver, how fast a turn is taken. For example, if a driver of a vehicle likes to make turns at a certain speed, the capture component 130 would make note of that and feed that input (e.g., via a vehicle configuration profile) into an autonomous vehicle when the vehicle is actually driving.

In this way, the capture component 130 may monitor one or more driving parameters associated with one or more of the entities. In other words, driving parameters collected by the capture component 130 may be used to ‘define’ a driver's driving habits or ‘driving style’. As discussed, the driver's driving style is not necessarily associated with the driver of the vehicle, but may be associated with cargo in the vehicle, for example.

Thus, the simulation component 120 and the capture component 130 may provide a virtual training system which captures driving parameters, which may be incorporated into an autonomous vehicle at a later time. In other words, the capture component 130 may gather data, such as sensor data from sensors of the capture component 130 to collect or gather information which may be used to make a determination or build a profile for an entity, such as a driver of a vehicle, for example.

The learning component 140 may supplement the driving parameters captured by the capture component 130 by establishing driving patterns using driving pattern recognition. In other words, the learning component 140 may learn one or more tendencies or one or more proclivities associated with an entity, such as a driver of a vehicle or driving characteristics common to cargo being transported. Thus, the learning component 140 may facilitate understanding of associated driving behaviors and incorporation of these driving behaviors into autonomous vehicles or autonomous vehicle modes. In this way, the learning component 140 may infer one or more driving parameters based on one or more of the monitored driving parameters. For example, if the simulation component 120 provides a first simulation stimuli, but not a second simulation stimuli, the learning component 140 may infer a response to a second simulation stimuli based on the response received to the first simulation stimuli.

The configuration component 150 may generate or build a vehicle configuration profile based on one or more of the driving parameters captured by the capture component 130. In other words, the vehicle configuration profile generated by the configuration component 150 may be indicative of a driving style associated with a driver, an occupant, passenger, cargo, or goods being transported on a vehicle. As discussed, the vehicle configuration profile may be indicative of a preferred driving style associated with the entity during transport. Stated another way, the configuration component 150 may build a vehicle configuration profile based on one or more of the driving parameters, wherein the vehicle configuration profile is associated with the entity.

In one or more embodiments, the configuration component 150 may transmit the vehicle configuration profile, such as to a device or portable device 112 or directly to a vehicle or a communication component 124 of a vehicle equipped with a system 192 for implementing a vehicle configuration. Thus, in some embodiments, the vehicle configuration profile may be stored on a server and made available for download to a vehicle. In other embodiments, the vehicle configuration profile may be transmitted to a physical device 112, such as a key fob, and transmitted to the communication component 124 of a vehicle locally or using near field communication, for example.

The system 192 for implementing a vehicle configuration within a vehicle may include a storage component 114, a communication component 124, a navigation component 134, an application program interface (API) component 144, a sensor component 154, a display component 164, and a style component 174.

The communication component 124 may receive a vehicle configuration profile associated with an entity, thereby making the vehicle configuration profile portable. In other words, a vehicle equipped with a vehicle configuration system may receive vehicle one or more vehicle configuration profiles and implement respective profiles accordingly. In this way, when the vehicle is operating in autonomous driving mode, the vehicle may follow a driving style associated with a corresponding vehicle configuration profile.

Because the communication component 124 may receive different vehicle configuration profiles associated with different individuals, drivers, entities, occupants, cargo, goods, etc., this makes vehicle configuration profiles portable, thereby enabling most any individual or item, such as cargo, to have a ride or be transported in a proper or accustomed fashion. The API component 144 may subsequently implement the vehicle configuration profile to cause a vehicle to operate in a familiar manner for an entity, as vehicle configuration profile may be indicative of a preferred driving style associated with the entity during transport across a plurality of simulated conditions.

For example, a taxi cab equipped with a system 192 for implementing a vehicle configuration may receive a vehicle configuration profile associated with a customer, occupant, or passenger, and cause the taxi to operate or maneuver accordingly (e.g., at least an autonomous driving portion of the taxi cab).

The storage component 114 may store or house a vehicle configuration profile received by the communication component 124 and provide data or information from the vehicle configuration profile to other components within the vehicle, such as the operation component or the application program interface (API) component 144.

The navigation component 134 may receive one or more navigation maneuvers from an origin location to a destination location. In other words, the navigation component 134 may provide a location, navigation instructions, turn by turn instructions, etc. These instructions or maneuvers may be used by the API component 144 to determine how to implement a vehicle configuration profile. For example, if a tight turn is coming up according to the navigation component 134, the API component 144 may implement a portion of the vehicle configuration profile pertaining to how an entity prefers tight turns to be made. In this way, if a driver of an autonomous vehicle likes to make turns at a certain speed, the driving parameters recorded by the capture component 130 may be mirrored or attempted to be mirrored by the API component 144 during vehicle operation.

The sensor component 154 may include one or more sensors or one or more sensor units, such as a radar unit, a lidar unit, a compass unit, a speedometer, an accelerometer, an image capture unit, a video unit, temperature sensors, weather sensors, vehicle component sensors (e.g., detecting malfunctioning vehicle components), etc. Accordingly, the sensor component 154 may be configured to detect objects or pedestrians, provide a video feed, utilize radar or lidar, receive one or more different weather conditions or one or more different temperature conditions, or provide a compass heading. In other words, the sensor component 154 may sense one or more actual conditions, thereby enabling the API component 144 to apply applicable vehicle configuration profile settings to operation of a vehicle. For example, if the sensor component 154 detects that it is raining, this information may be passed onto the API component 144, which may implement one or more driving parameters associated with rain from the vehicle configuration profile, thus causing the vehicle to operate in a manner which an associated entity is accustomed to while it is raining.

Examples of actual conditions sensed or detected may include pedestrians, other vehicles, one or more different weather conditions, one or more different temperature conditions, different traffic conditions, different terrain, navigation maneuvers along one or more road segments, etc.

The system 192 for implementing a vehicle configuration may include an application program interface component 144 which may take the data from the vehicle configuration profile generated by the simulation program or simulation platform and place that data into real-world driven autonomous vehicles. This vehicle configuration profile may be indicative of driving styles associated with one or more entities. In this way, the application program interface (API) component 144 may ‘place’ driving behaviors (e.g., via the vehicle configuration profile) from the simulation platform into different vehicles, such as autonomous vehicles, thereby making the driving behavior portable.

Further, the API component 144 may dynamically adjust implementation of the vehicle configuration profile according to one or more actual conditions, associated entities, vehicle capabilities, etc. For example, a vehicle configuration profile may indicate that an individual is an aggressive driver when he is by himself. However, the same vehicle configuration profile may indicate that he is far less aggressive when his children are in the backseat of the vehicle. Thus, using the sensor information from the sensor component 154, if weight is detected in the backseat, the API component 144 may implement the less aggressive driving parameters of the vehicle configuration profile, rather than the solo vehicle configuration profile driving parameters.

In this way, the API component 144 may operate the vehicle based on the vehicle configuration profile (e.g., drive or operate the vehicle according to data, information, or parameters associated with an active, implemented, or received vehicle configuration profile) and one or more of actual conditions or navigation information from the navigation component 134. Further, the API component 144 may operate the vehicle in an autonomous fashion, including an automated driving portion, which may utilize a driving algorithm which incorporates the vehicle configuration profile. This algorithm may be open source or crowd sourced to provide a lower barrier to entry for programming the autonomous vehicle.

The application program interface (API) component 144 may receive one or more inputs, such as a steering angle, desired velocity, and a vehicle configuration profile. Based on these, the application program interface (API) component 144 may autonomously operate the vehicle accordingly.

The display component 164 may render a video feed or one or more notifications associated with one or more of the actual conditions detected by the sensor component 154, such as a pedestrian detection notification, a video feed of obstacles, a current velocity, a compass heading, radar or lidar notifications, weather conditions, temperature conditions, vehicle component conditions, traffic conditions, collision, accident detection or mitigation notifications, etc.

The style component 174 may enable a user to adjust a vehicle configuration profile based on feedback from the entity or an associated user. For example, if a user does not feel in control, agree with how the vehicle ‘feels’, or wants to make the current ride feel more at home or like his or her ‘own’ ride, the style component may receive user input enabling the user to adjust the vehicle configuration profile. Further, the style component 174 may make suggestions based on driving parameters captured during creation of the vehicle configuration profile or based on the user input.

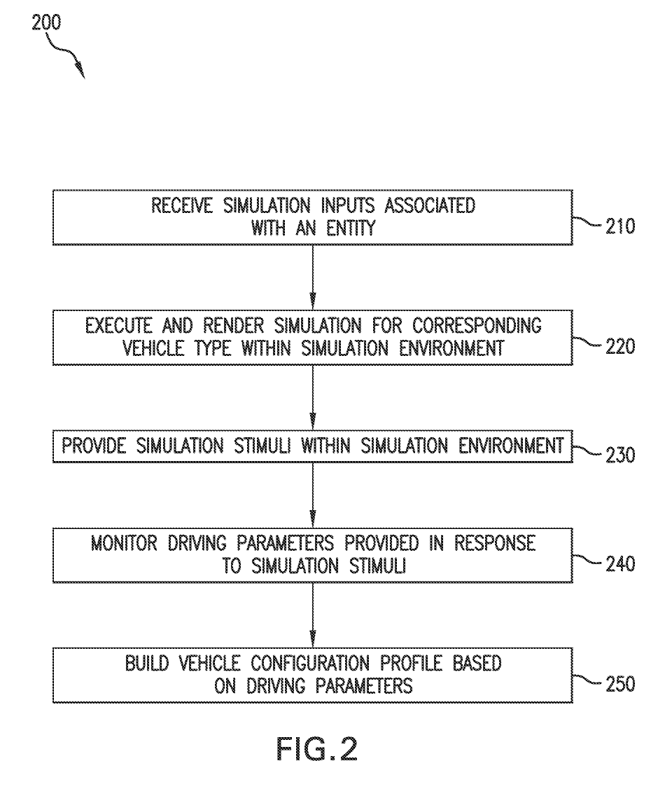

FIG. 2 is an illustration of an example flow diagram of a method 200 for managing a vehicle configuration, according to one or more embodiments. At 210, the method 200 may include receiving simulation inputs associated with an entity. At 220, a simulation may be executed and rendered for a corresponding vehicle type within a simulation environment. At 230, simulation stimuli may be provided within a simulation environment. For example, the simulation may introduce different weather conditions, additional traffic, pedestrians, etc. At 240, driving parameters (or driving behavior) in response to simulation stimuli may be monitored. At 250, a vehicle configuration profile may be built based on the monitored driving parameters.

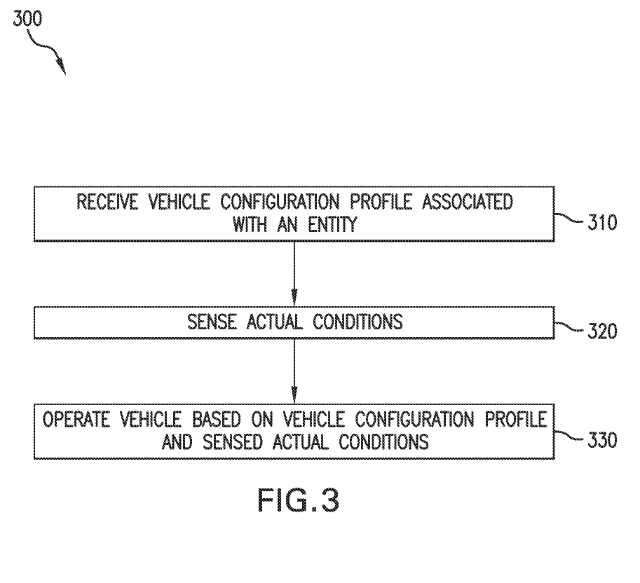

FIG. 3 is an illustration of an example flow diagram of a method 300 for implementing a vehicle configuration, according to one or more embodiments. At 310, a vehicle configuration profile may be received, the vehicle configuration profile may be associated with an entity, such as a driver, an occupant, cargo, goods, etc. being transported. At 320, actual conditions may be sensed or detected. For example, if it is snowing out, this may be sensed or detected. At 330, the vehicle may be operated, such as in an autonomous manner, based on the vehicle configuration profile and sensed actual conditions.

One or more embodiments may employ various artificial intelligence (AI) based schemes for carrying out various aspects thereof. One or more aspects may be facilitated via an automatic classifier system or process. A classifier is a function that maps an input attribute vector, x=(x1, x2, x3, x4, xn), to a confidence that the input belongs to a class. In other words, f(x)=confidence (class). Such classification may employ a probabilistic or statistical-based analysis (e.g., factoring into the analysis utilities and costs) to prognose or infer an action that a user desires to be automatically performed.

A support vector machine (SVM) is an example of a classifier that may be employed. The SVM operates by finding a hypersurface in the space of possible inputs, which the hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression utilized to develop models of priority.

One or more embodiments may employ classifiers that are explicitly trained (e.g., via a generic training data) as well as classifiers which are implicitly trained (e.g., via observing user behavior, receiving extrinsic information). For example, SVMs may be configured via a learning or training phase within a classifier constructor and feature selection module. Thus, a classifier may be used to automatically learn and perform a number of functions, including but not limited to determining according to a predetermined criteria.

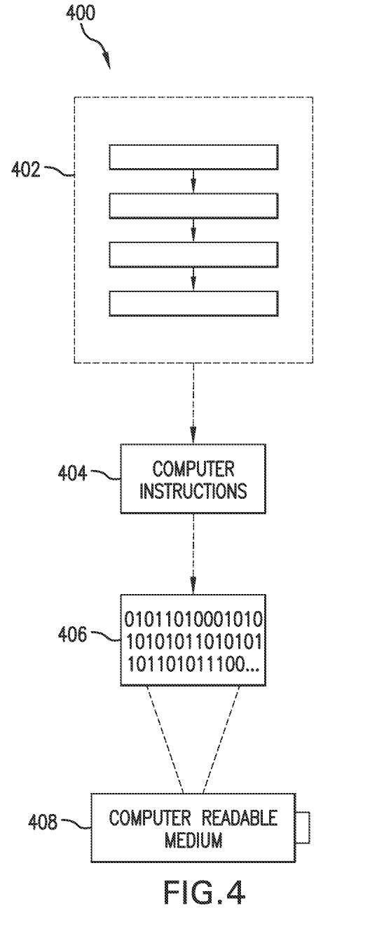

Still another embodiment involves a computer-readable medium including processor-executable instructions configured to implement one or more embodiments of the techniques presented herein. An embodiment of a computer-readable medium or a computer-readable device devised in these ways is illustrated in FIG. 4, wherein an implementation 400 includes a computer-readable medium 408, such as a CD-R, DVD-R, flash drive, a platter of a hard disk drive, etc., on which is encoded computer-readable data 406. This computer-readable data 406, such as binary data including a plurality of zero's and one's as shown in 406, in turn includes a set of computer instructions 404 configured to operate according to one or more of the principles set forth herein. In one such embodiment 400, the processor-executable computer instructions 404 may be configured to perform a method 402, such as the method 200 of FIG. 2 or the method 300 of FIG. 3. In another embodiment, the processor-executable instructions 404 may be configured to implement a system, such as the system 100 or the system 192 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

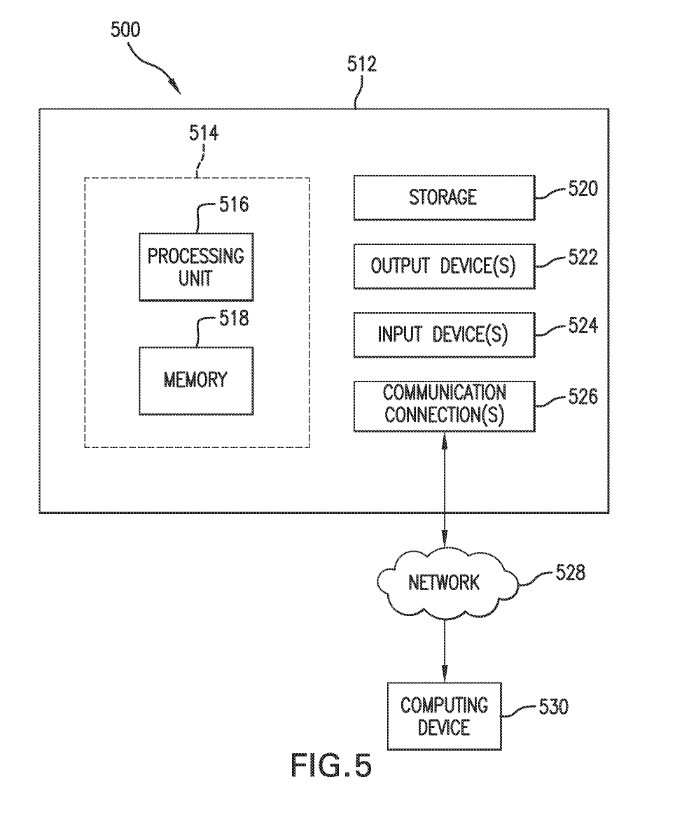

FIG. 5 and the following discussion provide a description of a suitable computing environment to implement embodiments of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one or more embodiments provided herein. In one configuration, computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other embodiments, computing device 512 includes additional features or functionality. For example, computing device 512 may include additional storage such as removable storage or non-removable storage, including, but not limited to, magnetic storage, optical storage, etc. Such additional storage is illustrated in FIG. 5 by storage 520. In one or more embodiments, computer readable instructions to implement one or more embodiments provided herein are in storage 520. Storage 520 may store other computer readable instructions to implement an operating system, an application program, etc. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by computing device 512. Any such computer storage media is part of computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with computing device 512. Input device(s) 524 and output device(s) 522 may be connected to computing device 512 via a wired connection, wireless connection, or any combination thereof. In one or more embodiments, an input device or an output device from another computing device may be used as input device(s) 524 or output device(s) 522 for computing device 512. Computing device 512 may include communication connection(s) 526 to facilitate communications with one or more other devices.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for managing a vehicle configuration, comprising:
an interface component receiving one or more simulation inputs associated with an entity, wherein one or more of the simulation inputs is a vehicle type or an input driving style;
a simulation component:
executing and rendering a simulation for the corresponding vehicle type within a simulation environment; and
wherein the simulation component provides one or more simulation stimuli within the simulation environment;
a capture component monitoring one or more driving parameters provided in response to one or more of the simulation stimuli; and
a configuration component building a vehicle configuration profile based on one or more of the driving parameters, wherein the vehicle configuration profile is associated with the entity,
wherein the interface component, the simulation component, the capture component, or the configuration component are implemented via a processing unit.

2. The system of claim 1, wherein the interface component receives identification data associated with the entity.

3. The system of claim 1, wherein the simulation component renders 3D images of the simulation environment or one or more of the simulation stimuli.

4. The system of claim 1, wherein one or more of the simulation stimuli are a pedestrian, one or more different weather conditions, one or more different temperature conditions, traffic conditions, or a turning maneuver.

5. The system of claim 1, wherein one or more of the driving parameters is a steering angle, a braking force, vehicle velocity during a turning maneuver, following distance, or a change in steering angle over time during a driving maneuver.

6. The system of claim 1, comprising a learning component inferring one or more driving parameters based on one or more of the monitored driving parameters.

7. The system of claim 1, wherein the vehicle configuration profile is indicative of a preferred driving style associated with the entity during transport.

8. The system of claim 1, wherein the configuration component transmits the vehicle configuration profile.

9. A system for implementing a vehicle configuration within a vehicle, comprising:
a communication component receiving a vehicle configuration profile associated with an entity, the vehicle configuration profile indicative of a preferred driving style associated with the entity during transport across a plurality of simulated conditions;
a sensor component sensing one or more actual conditions; and
an application program interface (API) component operating the vehicle based on the vehicle configuration profile and one or more of the actual conditions,
wherein the communication component, the sensor component, or the API component is implemented via a processing unit.

10. The system of claim 9, comprising a storage component storing the vehicle configuration profile.

11. The system of claim 9, comprising a navigation component receiving one or more navigation maneuvers,
wherein the API component operates the vehicle based on one or more of the navigation maneuvers and the vehicle configuration profile.

12. The system of claim 9, wherein the API component operates the vehicle in an autonomous fashion.

13. The system of claim 9, wherein the sensor component is configured to detect objects or pedestrians, provide a video feed, utilize radar or lidar, receive one or more different weather conditions or one or more different temperature conditions, or provide a compass heading.

14. The system of claim 13, comprising a display component rendering the video feed or one or more notifications associated with one or more of the actual conditions detected by the sensor component.

15. The system of claim 9, wherein one or more of the actual conditions are a pedestrian, one or more different weather conditions, one or more different temperature conditions, traffic conditions, or a turning maneuver.

16. The system of claim 9, comprising a style component adjusting the vehicle configuration profile based on feedback from the entity or an associated user.

17. A method for implementing a vehicle configuration within a vehicle, comprising:
receiving a vehicle configuration profile associated with an entity, the vehicle configuration profile indicative of a preferred driving style associated with the entity during transport across a plurality of simulated conditions;
sensing one or more actual conditions; and
operating the vehicle based on the vehicle configuration profile and one or more of the actual conditions,
wherein the receiving, the sensing, or the operating is implemented via a processing unit.

18. The method of claim 17, comprising:
receiving one or more navigation maneuvers; and
operating the vehicle based on one or more of the navigation maneuvers and the vehicle configuration profile.

19. The method of claim 17, comprising operating the vehicle in an autonomous fashion.

20. The method of claim 17, comprising adjusting the vehicle configuration profile based on feedback from the entity or an associated user.
